(19) United States
(12) Patent Application Publication
(10) Pub. No.: US 2009/0001805 A1
(43) Pub. Date: Jan. 1, 2009

(54) HYDRAULIC BY-WIRE BRAKE SYSTEM

(76) Inventors: Troy Eugene Schick, Cedar Falls, IA (US); Steven Daniel Wallestad, Cedar Falls, IA (US); Brian Lee Herbst, Cedar Falls, IA (US)

Correspondence Address: DEERE & COMPANY, ONE JOHN DEERE PLACE, MOLINE, IL, 61265, US

(21) Appl. No.: 11/768,423

(22) Filed: Jun. 26, 2007

(51) Int. Cl. B60T 13/14; B60T 13/00

(52) U.S. Cl. 303/9.61; 303/10

(57) ABSTRACT

A hydraulic circuit is provided for a by-wire brake system. There is a need for such a circuit which permits independent left and right brake operation and which has redundancy. The circuit includes left and right brake control valves, a left brake line communicated with a left brake, a right brake line communicated with a right brake, and a left-right cross-over valve operable to open and close communication between the left and right brake lines. The hydraulic circuit also includes a left shutoff valve between an outlet of the left brake valve and the left brake line, and a right shutoff valve between an outlet of the right brake valve and the right brake line.

### BACKGROUND

The present invention relates to a hydraulic circuit for a vehicle by-wire brake system.

Some vehicles, such as agricultural tractors, have brake systems wherein the left and right brakes can be independently controlled to assist with steering the vehicle. Such brake systems must also have a redundant brake valve and oil supply to insure brake function in the event of a single valve or supply failure.

By-wire brake systems in vehicles eliminate the mechanical link between the brake pedals and the road wheels, and permit the system to achieve desirable control characteristics. It is desirable to have an economical and reliable by-wire brake system which permits independently control of left and right brakes, and which has redundancy.

### SUMMARY

Accordingly, an object of this invention is to provide a hydraulic circuit for a by-wire brake system.

A further object of the invention is to provide such a system which permits independently control of left and right brakes.

A further object of the invention is to provide such a system which has redundant valves and which is cost effective.

These and other objects are achieved by the present invention, wherein a hydraulic circuit is provided for a by-wire braking system. The braking system includes a hydraulic pump, a reservoir, left and right pressure operated brake units. The hydraulic circuit includes a left brake line communicated with the left brake unit, a right brake line communicated with the right brake unit, and a left-right communication valve operable to open and close communication between the left and right brake lines. The hydraulic circuit also includes a left brake control valve controlling communication between the pump, the reservoir and the left brake line, and a right brake control valve controlling communication between the pump, the reservoir and the right brake line. The hydraulic circuit further includes a left shutoff valve between an outlet of the left brake valve and the left brake line, and a right shutoff valve between an outlet of the right brake valve and the right brake line.

Thus, the circuit includes redundant brake control valves to guarantee brake function in the event of a single valve failure. However, instead of using two valves for each side of the rear axle, a single valve is used on each side with a crossover valve which is opened when either the right or the left side brake valve fails. When the crossover valve is open, the brakes on both sides of the rear axle can be applied with either the right or left brake valve. During a failure condition, the ability to use independent right and left side brakes is disabled. In this manner, fewer valves can be used to achieve the redundancy required in a by-wire brake system.

### BRIEF DESCRIPTION OF THE DRAWINGS

The sole FIGURE is a schematic diagram of a hydraulic circuit for a by-wire brake system according to the present invention.

### DETAILED DESCRIPTION

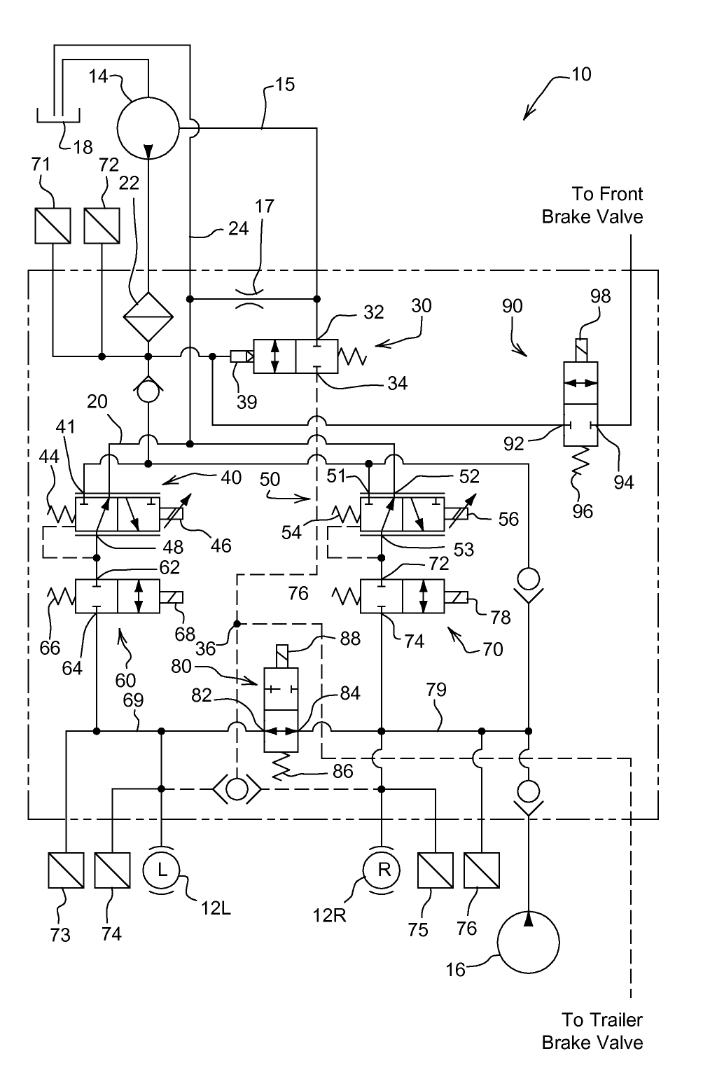

Referring to the FIG. 1, a by-wire brake system or circuit 10 includes a left wheel brake actuator 12L and a right wheel brake actuator 12R. System 10 also includes a main pump 14, a secondary pump 16 and a reservoir 18.

The outlet of pump 14 is connected to supply line 20 via filter 22. Return line 24 is connected to reservoir 18.

The circuit 10 includes a load sense blocking valve 30, a left solenoid operated brake control valve 40, a right solenoid operated brake control valve 50, a left shut-off valve 60, a right shut-off valve 70, a left-right communication valve 80, and a front brake shutoff valve 90.

Valve 30 has a first port 32 connected to pump 14 via load sense line 15 and connected to return line 24 via restriction 17. A second port 34 is connected to a load sense line 36 which is connected to brakes 12L and 12R and to a trailer brake valve (not shown). Valve 30 is urged to a closed position by spring 38 and to an open position by pressure responsive pilot 39. Pilot 39 is connected to supply line 20 downstream of filter 22 and to front brake shutoff valve 90.

Left brake control valve 40 has a first port 41 connected to supply line 20, a second port 42 connected to return line 24 and a third port 43 connected to valve 60. Valve 40 is urged to a first position by spring 44 and to a second position by solenoid 46. In its first position port 41 is closed and port 43 is connected to port 42. In its second position, port 41 is connected to port 43 and port 42 is closed.

Right brake control valve 50 has a first port 51 connected to supply line 20, a second port 52 connected to return line 24 and a third port 53 connected to valve 70. Valve 50 is urged to a first position by spring 54 and to a second position by solenoid 56. In its first position port 51 is closed and port 53 is connected to port 52. In its second position, port 51 is connected to port 53 and port 52 is closed.

Left shutoff valve 60 has a first port 62 connected to port 43 of valve 40, and a second port 64 connected to brake 12L via left brake line 69. Valve 60 is urged to a first position by spring 66 and to a second position by solenoid 68. In its first position ports 62 and 64 are closed. In its second position, port 62 is connected to port 64.

Right shutoff valve 70 has a first port 72 connected to port 53 of valve 50, and a second port 74 connected to brake 12R via right brake line 79. Valve 70 is urged to a first position by spring 76 and to a second position by solenoid 78. In its first position ports 72 and 74 are closed. In its second position, port 72 is connected to port 74.

Left-right communication or crossover valve 80 has a first port 82 connected to port 64 of valve 60 and to the left brake 12L, and a second port 84 connected to port 74 of valve 70 and to right brake 12R. Valve 80 is urged to a first position by spring 86 and to a second position by solenoid 88. In its first position port 82 is connected to port 84. In its second position, ports 82 and 84 are closed.

Secondary pump 16 has an outlet communicated to supply line 20 and to ports 74, 84, and to right brake line 79. The secondary pump 16 is preferably driven by an electric motor. The pump 16 thus is connected to the inlets of the brake control valves 40 and 50 and to their outlets via valves 60 and 70.

Front brake shutoff valve 90 has a first port 92 connected to supply line 20, and a second port 94 connected to a front brake valve (not shown). Valve 90 is urged to a first position by spring 96 and to a second position by solenoid 98. In its first position ports 92 and 94 are closed. In its second position, port 92 is connected to port 94.

Pressure transducers T1-T6 are connected to different places in the circuit 10, to supply pressure signals to an electronic control unit (not shown).

When valve 80 blocks communication between ports 82 and 84, the brakes 12L and 12R can be independently controlled by valves 40 and 50, respectively. With valve 80 opens communication between ports 82 and 84, the brakes 12L and 12R can be controlled together, either by valve 40 or by valve 50, thus providing redundancy. When valve 40 is controlling both brakes 12L and 12R, valve 70 can be moved to its blocking position to isolate valve 50 from the brakes 12L and 12R. Similarly, when valve 50 is controlling both brakes 12L and 12R, valve 60 can be moved to its blocking position to isolate valve 40 from the brakes 12L and 12R.

While the present invention has been described in conjunction with a specific embodiment, it is understood that many alternatives, modifications and variations will be apparent to those skilled in the art in light of the foregoing description. Accordingly, this invention is intended to embrace all such alternatives, modifications and variations which fall within the spirit and scope of the appended claims.

We claim:

1. A hydraulic by-wire vehicle braking system, comprising:
a hydraulic pump;
a hydraulic reservoir;
left and right pressure operated wheel brake units;
a left brake line communicated with the left brake unit;
a right brake line communicated with the right brake unit;
a left-right communication valve operable to open and close communication between the left and right brake lines;
a left brake control valve controlling communication between the pump, the reservoir and the left brake line; and
a right brake control valve controlling communication between the pump, the reservoir and the right brake line.

2. The braking system of claim 1, further comprising:
a left shutoff valve between an outlet of the left brake valve and the left brake line; and
a right shutoff valve between an outlet of the right brake valve and the right brake line.

3. The braking system of claim 1, wherein:
each shutoff valve includes a spring which biases the shutoff valve to a position blocking communication between the corresponding brake valve and brake line; and
each shutoff valve includes a solenoid which is operable to move the shutoff valve to a position opening communication between the corresponding brake valve and brake line.

4. The braking system of claim 1, further comprising:
a secondary pump supplying pressurized fluid to inlets of the left and right brake valves.

5. The braking system of claim 1, wherein:
each brake valve includes a spring which biases the brake valve to a position blocking communication between the pump and the brake lines; and
each brake valve includes a solenoid which is operable to move the brake valve to a position opening communication between the pump and the brake lines.

6. The braking system of claim 1, wherein:
the left-right communication valve includes a spring which biases the left-right communication valve to a position opening communication between the brake lines; and
the left-right communication valve includes a solenoid which is operable to move the left-right communication valve to a position closing communication between the brake lines.

7. A hydraulic by-wire vehicle braking system, comprising:
a hydraulic pump;
a hydraulic reservoir;
left and right pressure operated wheel brake units;
a left brake line communicated with the left brake unit;
a right brake line communicated with the right brake unit;
a left-right communication valve operable to open and close communication between the left and right brake lines;
a left brake control valve controlling communication between the pump, the reservoir and the left brake line;
a right brake control valve controlling communication between the pump, the reservoir and the right brake line;
a left shutoff valve between an outlet of the left brake valve and the left brake line; and
a right shutoff valve between an outlet of the right brake valve and the right brake line.

8. A hydraulic by-wire vehicle braking system, comprising:
a hydraulic pump;
a hydraulic reservoir;
left and right pressure operated wheel brake units;
a left brake line communicated with the left brake unit;
a right brake line communicated with the right brake unit;
a solenoid operated cross-over valve operable to open and close communication between the left and right brake lines;
a solenoid operated left brake control valve controlling communication between the pump, the reservoir and the left brake line;
a solenoid operated right brake control valve controlling communication between the pump, the reservoir and the right brake line;
a solenoid operated left shutoff valve between an outlet of the left brake valve and the left brake line; and
a solenoid operated right shutoff valve between an outlet of the right brake valve and the right brake line.
